(19) United States
(12) Patent Application Publication
(10) Pub. No.: US 2014/0032938 A1
(43) Pub. Date: Jan. 30, 2014

(54) Power Management

(71) Applicants: Craig Bennett Greenberg, Mount Vernon, TX (US); Marcus Herzog, Finsing (DE)

(72) Inventors: Craig Bennett Greenberg, Mount Vernon, TX (US); Marcus Herzog, Finsing (DE)

(73) Assignee: Texas Instruments Incorporated, Dallas, TX (US)

(21) Appl. No.: 13/560,859

(22) Filed: Jul. 27, 2012

(51) Int. Cl. G06F 1/26

(52) U.S. Cl. 713/300

(57) ABSTRACT

A system includes a power supply system, a power management system, and a module. The module communicates to the power management system a variable parameter indicating power usage by the module and the power management system changes an operating range of the power supply system in response to the communication from the module.

### BACKGROUND

Complex electronic systems may comprise many different modules, circuit blocks, logical partitions, or functional units, not all of which are needed at any one time. While some modules may be fully operational, other modules may be powered off, or in a standby mode, or operating in a low-power mode. The power requirements for the system and individual modules may vary dynamically over time. In general, overall system power efficiency is important to minimize power usage, to reduce heat, to improve reliability, and to reduce operating costs. For battery operated systems it is important to maximize operating time without having to change or charge batteries. There is an ongoing need for improved power management.

### BRIEF DESCRIPTION OF THE DRAWINGS

FIG. 1 is a block diagram illustrating an example embodiment of a power supply.

FIG. 2 is a block diagram illustrating an example embodiment of a system.

FIG. 3 is a block diagram illustrating an example embodiment of a message.

FIG. 4 is a flow diagram illustrating an example embodiment of a method.

### DETAILED DESCRIPTION

In general, the power supplies for a system need to be able to provide worst case system current loading. In general, there is some overhead power required by the power supply itself, for example switching losses, conductive losses, etc. One particular power supply example is a Low Dropout (LDO) regulator. An LDO regulator is a linear voltage regulator having a pass transistor between the input voltage and the output voltage, and the voltage drop across the pass transistor can be very low. An LDO regulator has some quiescent current (the difference between input and output currents) and some quiescent current flows through the regulator core even when no load is present. When the load current is low, the quiescent current becomes an important factor. For example, in a battery operated system that is usually in a low power mode, quiescent current may be a primary limiter on battery life. Typically, the pass transistor has a bias current that enables the pass transistor to conduct some maximum amount of load current. The bias current determines much of the quiescent current.

FIG. 1 illustrates a simplified LDO regulator 100. In the example embodiment of FIG. 1, a pass transistor 102 is controlled by a feedback amplifier 104. The feedback amplifier compares a fraction of the output voltage V_{OUT} (as determined by R₁ and R₂) to a reference voltage V_{REF} to control the pass transistor to provide a constant output voltage. In addition, the pass transistor is biased by a bias current source 106. In the example embodiment of FIG. 1, the bias current source 106 is controlled by a control circuit 108 receiving an N-bit digital control signal S_{N}. Instead of operating with a fixed bias current to enable a maximum system load current, the LDO regulator of FIG. 1 may have multiple operating ranges, where the operating parameters are optimized to maximize efficiency within each relatively narrow operating range. The LDO illustrated in FIG. 1 is simplified and in general the control circuit 108 may modify more than just a single bias current source.

Alternatively, a power supply system may have multiple regulators, each optimized for an operating range, and one regulator may be selected depending on the power output needed by the power supply system. In particular, for systems with LDO regulators, a separate regulator may be used in the lowest power mode. That separate regulator may be optimized for very low power. As an alternative example, for high power systems, multiple transistor switches may be operated in parallel, and the number of parallel transistor switches may be adjusted to meet the system's current demand and to optimize efficiency. Alternatively, entire power supplies may be operated in parallel, and the number of supplies being operated in parallel may be adjusted to meet the system's current demand and to optimize efficiency.

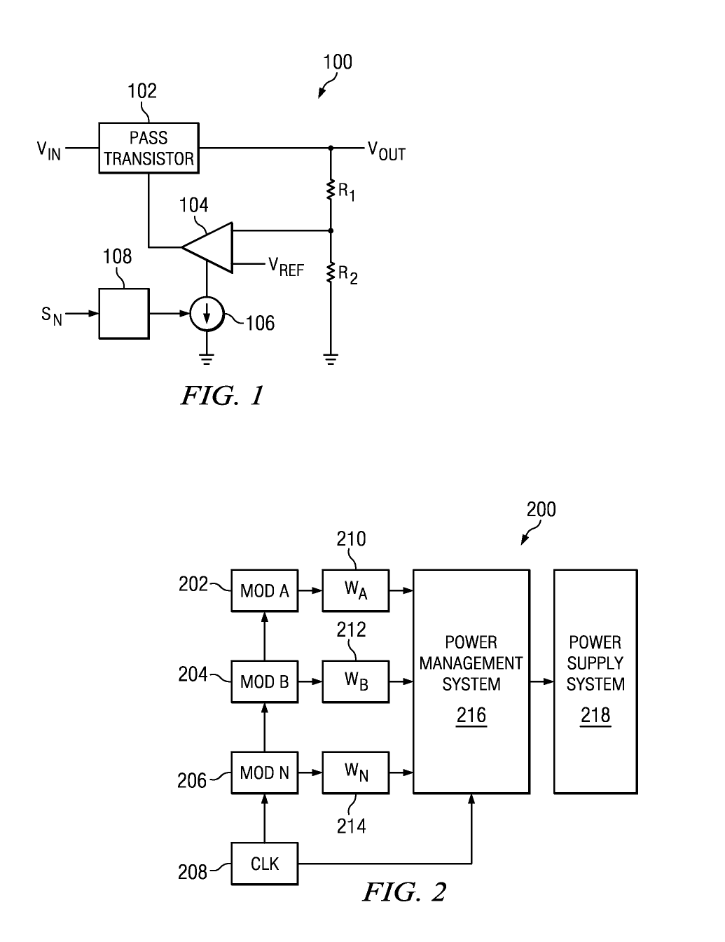

FIG. 2 illustrates an example embodiment of a system 200 in which modules (202, 204, 206) are configured to send a digital message to a power management system 216 regarding power usage. The power management system in turn controls a power supply system 218. The power supply system 218 has multiple operating ranges and the power management system 216 controls the operating range of the power supply system based on the power usage messages from the modules. The LDO regulator of FIG. 1 is one example of a power supply system with multiple operating ranges. As discussed above, other examples include multiple power supplies (of which one is selected), a number of parallel transistors (of which the number of active transistors is selected), or a number of parallel power supplies (for which the number of active supplies is selected).

In the simplest example embodiment, each active module sends a binary “one” to the power management system to indicate that it is powered on. In the simplest example embodiment, the power supply system has two operating ranges. When the number of active modules is below a fixed threshold, the power management system controls the power supply system to operate in a first operating range, and when the number of active modules exceeds the fixed threshold, the power management system controls the power supply system to operate in a second operating range.

Alternatively, the power supply system may have more than two operating ranges, and the power management system may have more than one threshold, so that when the number of active modules exceeds a particular threshold, the power management system controls the power supply system to switch to an operating range appropriate for the power usage of the number of active modules.

The simplest example embodiment described above assumes that all modules have approximately the same power usage, so that the only information needed by the power management system is just the number of active modules. In an alternative example embodiment, weighting factors (210, 212, 214) may to used to indicate relative power requirements for modules. For example, each weighting factor may indicate a multiple of a basic power requirement. Assume for example that Module A requires a standard amount of power, and that Module B requires twice as much power as a standard module. Weighting factor W_{A} (210) may then by 1.0, and weighting factor W_{B} (212) may then be 2.0. With this example, the power management system may determine a weighted sum of the power usage for all the active modules, and when the weighted sum exceeds one of multiple fixed thresholds, the power management system controls the power supply system to switch to an operating range appropriate for the power usage of the active modules.

In the example embodiment of FIG. 2, the weighting factors (210, 212, 214) are depicted as separate logic. Alternatively, the weighting factors can be implemented within the modules or within the power management module. For example, instead of modules communicating just whether they are active, modules may communicate their relative power usage. For example, when Module A is active, it could send the value 1.0 to the power management system, and when Module B is active, it could send the value 2.0 to the power management system.

Most digital circuits use clock signals, and power usage may vary with clock frequency. The clock frequency for a digital circuit may be changed by changing an adjustable frequency clock or by selecting a clock among two or more fixed-frequency clocks. Digital circuits may be operated in a reduced power mode or standby mode by operating at a reduced clock frequency. Alternatively, digital circuits may be operated in an enhanced performance mode by operating at a higher than normal clock frequency. Accordingly, clock usage can be used as a measure of power requirements. In the example embodiment of FIG. 2, a clock module 208 provides a clock signal to all modules. That clock signal may be variable. In an alternative example embodiment, the clock module 208 sends information regarding the clock signal being used to the power management system. This clock signal information may be a binary value (for example, operational mode or standby mode), or a number indicating one of multiple clock frequencies, or may be the actual clock frequency. The power management system may then use this clock information to adjust the power usage of the modules.

Alternatively, active modules may send a message to the power management system stating clock usage. For example, a module may send a message specifying which clock it is using, or alternatively may send a message indicating its clock frequency.

Alternatively, the power management system may have knowledge of the power requirements of each module type. For example, part of the message may indicate a module type, and the power management system may know the power usage of each type. Accordingly, the power management system will determine overall power usage based on the total power usage of all the active modules.

Alternatively, the power management system may have knowledge of the power requirements of each module as a function of clock frequency. Accordingly, the power management will determine overall power usage based on the total power usage of all the active modules as also modified by the clock frequency being used by each module.

Optionally, if weighting factors are used, modules may change corresponding weighting factors. For example, a module of type “Y” may have multiple operating states, or may be configured to operate in a “turbo” or “boost” mode, and the module may need to be able to adjust its weighting factor to indicate to the power management system that it is not a standard type “Y” module.

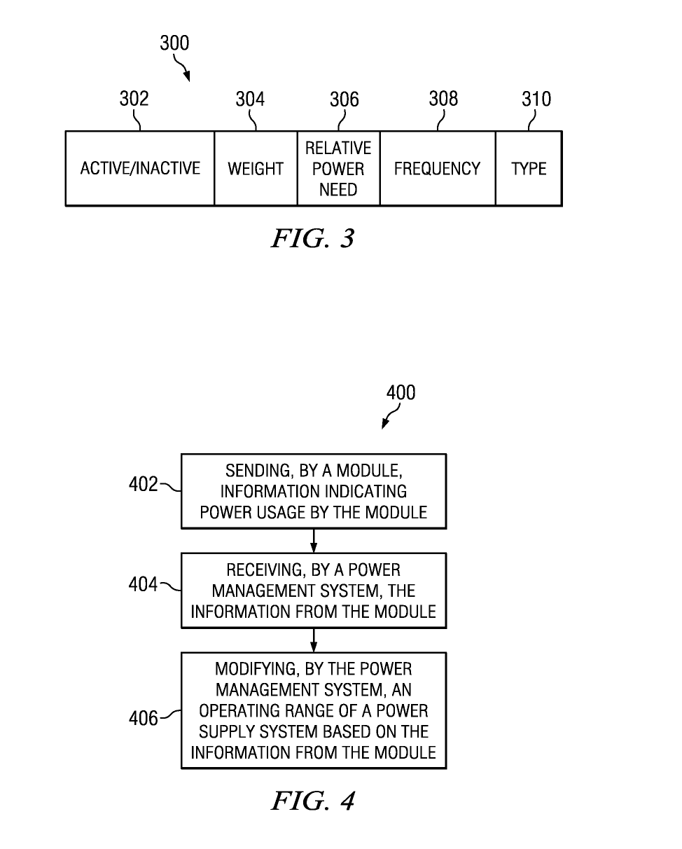

FIG. 3 illustrates an example digital message 200 that may be sent from a module to the power management system. In the example of FIG. 3, the message has many optional parts, and an actual message may comprise some subset of those optional parts. Note also that the blocks of FIG. 3 are just examples for illustration. The contents and order of contents of a message may vary from what is illustrated in FIG. 3. The only requirement is for the power management system to receive sufficient information to enable power supply range adjustment as a function of module power usage. Block 302 depicts a binary value indicating whether a module is active or inactive. As discussed above, a message may simply consist of just block 302. Block 304 depicts a weighting factor within a message. As discussed above, weighting factors may be implemented separately, and a module may optionally modify its own weighting factor. Block 306 depicts a relative power usage by the module. Block 308 depicts a variable specifying a clock frequency being used by a module. As discussed above, a clock frequency message may be sent by a clock module that generates a clock signal, or by a module using the clock signal. A variable specifying clock frequency may be a frequency, or just identification of a particular clock. Block 310 depicts a module type, which the power management system will associate with power requirements for the specific module type.

FIG. 4 illustrates an example embodiment 400 for a method of power management. At step 402, a module sends information indicating power usage by the module. At step 404, a power management system receives the information from the module. At step 406, the power management system modifies an operating range of a power supply system in response to the information from the module.

What is claimed is:

1. A system comprising:
a power supply system, the power supply system having at least two operating ranges;
a power management system configured to control which operating range is being used by the power supply system;
at least one module, the module configured to communicate to the power management system a variable parameter indicating power usage by the module; and
the power management system configured to change the operating range of the power supply system in response to the communication from the module.

2. The system of claim 1, further comprising:
a weighting factor, where the variable parameter is multiplied by the weighting factor before being communicated to the power management system.

3. The system of claim 2, further comprising:
the power management system configured to change the operating range of the power supply system in response to a weighted sum of variable parameters.

4. The system of claim 2, further comprising:
the module configured to modify the weighting factor.

5. The system of claim 1, further comprising:
the variable parameter comprising a binary status indicating one of active and inactive.

6. The system of claim 1, further comprising:
the variable parameter comprising a weighting factor.

7. The system of claim 1, further comprising:
the variable parameter indicating the relative power requirements of the module.

8. The system of claim 1, further comprising:
the variable parameter indicating clock frequency used by the module.

9. The system of claim 8, further comprising:
the parameter indicating clock frequency being sent by a clock module.

10. The system of claim 1, further comprising:
the variable parameter comprising an identification of module type.

11. The system of claim 1, further comprising:
the power management system configured to modify a bias current in a power supply in the power supply system.

12. The system of claim 1, further comprising:
the power management system configured to select one of a plurality of power supplies in the power supply system.

13. The system of claim 1, further comprising:
the power management system configured to select a number of parallel transistors in a power supply in the power supply system.

14. The system of claim 1, further comprising:
the power management system configured to select a number of parallel power supplies in the power supply system.

15. A system comprising:
a power supply system;
a power management system configured to select at least one operating range of the power supply system;
at least one module receiving a clock signal, the module configured to communicate to the power management system a variable parameter determined by the clock signal; and
the power management system configured to change the operating range of the power supply system in response to the communication from the module.

16. A method, comprising:
sending, by a module, information indicating power usage by the module;
receiving, by a power management system, the information from the module; and
modifying, by the power management system, an operating range of a power supply system based on the information from the module.

17. The method of claim 16, the step of modifying further comprising:
modifying a bias current in a power supply in the power supply system.

18. The method of claim 16, the step of modifying further comprising:
selecting one of a plurality of power supplies in the power supply system.

19. The method of claim 16, the step of modifying further comprising:
selecting a number of parallel transistors in a power supply in the power supply system.

20. The method of claim 16, the step of modifying further comprising:
selecting a number of parallel power supplies in the power supply system.
